(19) United States
(12) Patent Application Publication
(10) Pub. No.: US 2019/0012385 A1
(43) Pub. Date: Jan. 10, 2019

(54) COMPACT AUTONOMOUS NETWORK DEVICE FOR STORING AND VIEWING DATA

(71) Applicant: VALERIY VALEREVICH SLEPICHKO, MOSCOW (RU)

(72) Inventor: VALERIY VALEREVICH SLEPICHKO, MOSCOW (RU)

(21) Appl. No.: 16/128,842

(22) Filed: Sep. 12, 2018

Related U.S. Application Data
(63) Continuation of application No. PCT/RU2016/000507, filed on Oct. 28, 2016.

(30) Foreign Application Priority Data
Mar. 14, 2016 (RU) 2016109005

(51) Int. Cl. G06F 17/30; H04L 29/06; G06F 9/54; H04L 29/08; H04W 4/80

(52) U.S. Cl. CPC G06F 17/30864; G06F 17/30174; H04L 63/0861; G06Q 50/01; H04L 67/06; H04W 4/80; G06F 9/54

(57) ABSTRACT

A compact stand-alone network data storage and viewing device. The device includes: a CPU with a RAM; a long-term memory; a module for interacting with external physical data media; a wireless communication module; an internal display; an audio module; and an authentication module. The CPU can request authentication data and compare it with the user input data, and transfer control to the data processing program. The wireless communication module includes: NFC media configured to collect multimedia data from external devices to the long-term memory and to exchange multimedia data stored in the long-term memory with external devices for group use of multimedia data; and communication media in the Internet configured to collect multimedia data from remote devices and record the multimedia data into the long-term memory and to exchange multimedia data stored in the long-term memory with other remote devices for group use of multimedia data.

### CROSS REFERENCE TO RELATED APPLICATIONS

This application is the U.S. national phase of international application PCT/RU2016/000736 filed Oct. 28, 2016 which designated the U.S., and claims the priority of Russian patent application No. 2016109005 filed Mar. 14, 2016, the entire contents of both of which are hereby incorporated by reference.

### FIELD OF INVENTION

A compact stand-alone network data storage and viewing device is designed for collecting and archiving data from various sources in both field and stationary conditions followed by data exchange between different devices and data viewing on both built-in and external display devices (monitor, television or projector).

### BACKGROUND OF THE INVENTION

At present, the exponential growth in the amount of data stored on various devices results in two main problems: related to long-term data storage and later use of these data. For example, the increase in the resolution of photo and video camera sensors, especially on mobile devices, leads to an exponential growth in the number and volume of media files. Available high-quality audio equipment requires higher-quality audio materials of larger volume. This increase is much faster than the growth of the internal memory volume of mobile phones or memory cards size used in photo and video devices, and is faster than the rate of growth of the bandwidth of the heterogeneous wireless data infrastructure in the environment. The possibilities of using high resolution lead to a desire to create and store video and photo materials with high quality images in formats with redundant information and without compression, such as: RAW (“raw”, i.e. without any changes); lossless 7.1 audio (8-channel audio stream without compression and loss of quality); UHDTV (Ultra-High Definition Television); 3D (three-dimensional video); photos with variable depth, etc., which leads to an exponential increase in memory volume required. The up-to-date model of creating and using various data involves extensive use of data transfer between different various devices. For example, data created on mobile phones or cameras, audio, video data, etc. are usually transferred to the computer for editing or storing, or transmitted to third-party servers for Internet publishing, etc. For comfortable mass data processing, a high data transmission rate is required and, as a rule, the in-home wireless network bandwidth is insufficient, not to mention the bandwidth of mobile networks, Internet or public network service.

The second issue is that if there is no service for cloud data synchronization (data synchronization means maintaining the data identity in different storage locations based on the date of their creation or last modification), if the mobile device is lost or broken all the data stored on it can be lost. Generally, such data arrays are stored on home computers or external hard drives. If the computer has to be replaced, enormous data arrays have to be transferred to a new location. This results in the need for data archiving or synchronization. The so-called network attached storages (NAS), which can be accessed through network services, can partly solve this problem. If there is a need to access a great number of large media files (slideshows, UHDTV, etc.), there is a problem with time delays due to network bandwidth. The problem of wireless network bandwidth is especially topical as regards access from public places, so when the memory card or mobile device memory is full, a new memory card or computer is required to transfer the files to the drive. If a person is away from their in-home local network or home computer, there may be problems associated with the need for additional actions to archive or synchronize data and ensure later access to these archives. In case of the network archive, there are problems with the bandwidth, because the content is usually viewed on the computer or mobile device screen if there is access via the local network. If the archive is stored on the external hard drive, there may be problems with access to the archive contents from other devices and with restrictions for group viewing. Much of the above mentioned problems require special user skills.

There is a prior device NSB-25 by NextoDI Co. Ltd. (http://www.nextodi.com/product/en_nsb25.html) that allows in-the-field data copying from memory cards to the internal hard drive followed by viewing data on a built-in LCD screen or external display devices such as a monitor, television, or projector. However, this device does not allow data exchange via the local network or the Internet to work with them on other devices or by using network services.

There is also a prior device HyperDrive ColorSpace UDMA2 by Sanho Corporation (http://www.hypershop.com/products/hyperdrive-colorspace-udma3), which allows in-the-field data copying from a memory card to an internal hard drive followed by viewing data on the built-in LCD screen or web browser of the external device. However, this device does not allow exchanging data via the local network or the Internet with other devices or network services, or displaying information on external display devices, such as monitors, televisions, or projectors.

There is a prior device described in US 20030120756 A1 (Icp Electronics Inc., 2003 Jun. 26) concerning a mobile network-attached storage representing a data storage device accessed through a client's browser. However, this device does not allow exchanging data via the local network or the Internet with other devices or network services, or external data storage media, such as memory cards and USB memory sticks, nor displaying information on external display devices, such as monitors, televisions, or projectors.

There is a prior device disclosed in US 2015/0304707 (2015 Oct. 22), which is a private home cloud hub, as well as a method and system of home cloud infrastructure that allows to avoid problems arising from the use of public cloud services. The basic idea of the invention is to use specialized software that provides access to cloud data from all kinds of devices, such as computers, phones or any other devices with a built-in communication module. However, the publication does not describe a compact stand-alone device with the possibility to exchange data with other devices and memory cards, or display information on external display devices, rather it only implements the concept of combining all kinds of devices into a home cloud structure.

Prior art device NVS2825, by NextoDI Co. Ltd. (http://www.nextodi.com/product/en_nvs2825.html), allows in-the-field copying data from memory cards to the long-term storage device, with the possibility to view data later on the built-in screen or web browser of an external device. However, this device does not contain authentication tools nor does it have a screen for full data viewing, nor advanced data exchange capabilities (archiving, time of modification synchronization, etc.) via wireless interfaces with other devices through the local network or the Internet or with network services or via near field wireless communication, nor does it display information to the external display devices such as monitors, televisions, or projectors.

### DISCLOSURE OF INVENTION

To overcome the above-mentioned deficiencies of the prior art, a compact stand-alone network data storage and viewing device is proposed that has a user authentication function and possible physical and/or wireless connection to various data sources for exchange, storage and viewing on a built-in screen of the device and/or screens of external devices.

In order to enable data exchange in any convenient location followed by convenient access thereto, the compact stand-alone network storage and viewing device of the present invention is pocket-sized, allowing for easy carriage and usage in any convenient location, due to an independent power supply source. To ensure security of the stored data, the device includes an authentication module that ensures access security to the stored device data due to the ability of the device itself to authenticate the user with the help of fingerprint scanning, iris scanning and/or the like. To view and handle the stored data in any convenient place, the device contains its own video display unit (screen, built-in display) and audio system (audio module). The device includes a module for interacting with external data media to handle the data on physical media such as a USB Flash Drive (a data storage medium with a universal serial bus), external hard drive, SD (Secure Digital Card), MMC (MultiMedia Card), Memory Stick, Compact Flash and the like. To store the data, the device contains a long-term storage device, for example, HDD (Hard Disk Drive) and/or SSD (Solid-State Drive) and/or other types. To exchange data with other devices that have wireless data transmission or are connected to a local network or the Internet, the device includes a wireless communication module supporting data transfer via wireless communication lines such as WiFi, Bluetooth, NFC (Near Field Communication), Li-Fi (Light Fidelity, i.e., an optical wireless data transfer technology) and the like. To handle the stored data comfortably, the device includes a multimedia module for working with multimedia interfaces such as HDMI (High Definition Multimedia Interface), DVI (Digital Video Interface), MHL (Mobile-High-Definition) and the like, which allows connecting the device to external high-resolution display devices.

In particular, the device allows an authenticated user to exchange data with other users, store data both in a stationary environment, and directly at the data creation location, for example, while traveling, when participating in various events, etc. In case of stationary use, the device provides data exchange with various physical data media connected to the device, as well as with various remote devices. When connected to an external display device, the present device allows viewing the stored data in a group-friendly form.

The device (FIG. 1) generally includes a central processing unit, random access memory (RAM), long-term memory, at least one interaction module with external data media, at least one wireless communication module, at least one authentication module, at least one multimedia module, at least one audio system, at least one information display unit, and at least one independent power supply. The processor operation is ensured by the device operating system, which controls the operation of all modules and external devices. RAM is used to speed up the operating system execution. The long-term memory such as HDD (Hard-Drive Disk) and/or SSD (Solid-State Disk) and/or the like, stores all user data and operating system files, including programs that monitor and coordinate the operation of various modules (devices) and elements of the device handle data processing, such as device module activity monitoring program, authentication program, data processing program, and others.

The device also includes a module for interacting with external physical media providing data exchange with such external storage media (FIG. 2) as SD memory cards, MMC, Compact Flash, Memory Stick, USB Flash Drive, external hard drive and the like. When an external data medium is connected to the device through an interaction module with an external physical data carrier, the device module activity monitoring program detects a new connection and activates the authentication module. In case of successful authentication, the device prompts the user to select the necessary actions through the user interface on the built-in display device, such as data copying, data transfer, data creation time synchronization, browsing and the like. As a user selects necessary actions, the data are exchanged between the external physical data carrier and the device. Due to the different operation speeds of various storage devices, the operating system can pre-copy data to RAM to speed up the data exchange process. Using built-in wireless communication modules, the device exchanges data between network services or between other external devices with wireless data exchange modules and without them, but connected to the network infrastructure that provides communication with them. The device module activity monitoring program continually checks the activity of the wireless communication module and, in case activity is detected, attempts to establish communication with the paired (linked, conjugated, connected) device (i.e. with a device whose data exchange has been pre-reconciled via near field wireless communication (Bluetooth, NFC, and the like) and/or through the local network and/or the Internet (via WiFi, 4G, 5G (data transfer via mobile communication) and the like). Furthermore, when access to the Internet is detected, the device exchanges data with a coordination server of the peer-to-peer network using a wireless module to update information about paired data, as well as with other network services such as Yandex.Disk, Twitter, Facebook, etc. Additionally, the device is equipped with a multimedia module supporting such high-resolution image transmission technologies as HDMI and/or DVI and/or MHL or the like. When connecting to the multimedia module of the external display device (FIG. 2), such as a monitor and/or television and/or projector or the like, the device module activity monitoring program activates the authentication module and, in case of successful authentication, displays the image from the built-in screen to the external display device via the multimedia module supporting high-resolution standards. The device thus allows for viewing the data stored therein with high quality and group-friendly viewing. The independent power supply allows the device to operate in the field.

The power supply control program manages power supply to the built-in modules of the device, monitors the charge of the independent power supply, and the device's mains-fed operation.

The device module activity monitoring program registers the activity of the device modules, such as attempts of external devices to connect to the wireless module of the device via wireless communication lines, or attempts of network services, or the peer-to-peer coordination server; connection to the external data media interaction module of the external data media; connection to the multimedia module of the external display devices; connecting the device to the mains, etc. If the activity of one of the modules is detected, the program transfers the controls to the authentication program.

The user authentication program operates with the authentication module. Using the authentication program, new users of the device are created, and user credentials are edited. When creating a new user, the program receives credentials from the authentication module (digital image of a fingerprint or retina, or the like) and stores it in the long-term memory. To access the device, the authentication program requests credentials from the authentication module and compares them to those stored in the long-term memory. In case of a coincidence of credentials, authentication is considered successful and control is transferred to the data processing program.

The data processing program makes settings and parameters for interfacing data between different devices or network services; it provides access to data viewing, performs various operations with data (copying, moving, deleting, etc.).

### SUMMARY OF THE INVENTION

A compact stand-alone network data storage and viewing device. The device includes: a CPU with a RAM; a long-term memory; a module for interacting with external physical data media; a wireless communication module; an internal display; an audio module; and an authentication module. The CPU can request authentication data and compare it with the user input data, and transfer control to the data processing program. The wireless communication module includes: NFC media configured to collect multimedia data from external devices to the long-term memory and to exchange multimedia data stored in the long-term memory with external devices for group use of multimedia data; and communication media in the Internet configured to collect multimedia data from remote devices and record the multimedia data into the long-term memory and to exchange multimedia data stored in the long-term memory with other remote devices for group use of multimedia data.

### BRIEF DESCRIPTION OF THE DRAWINGS

FIG. 1 shows the internal structure of the compact stand-alone network data storage and viewing device of the present invention.

FIG. 2 shows an interaction diagram of the present device with external devices or network services.

### DETAILED DESCRIPTION OF THE INVENTION

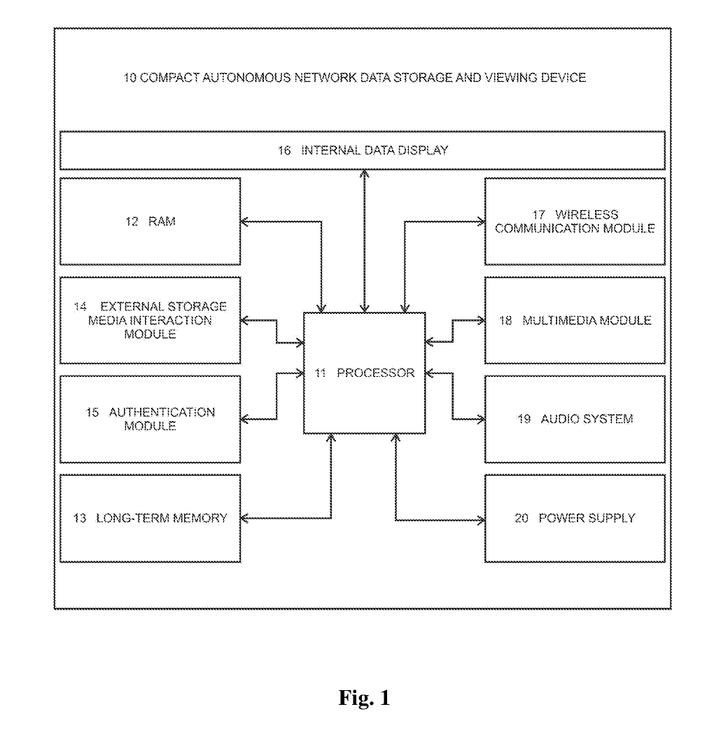

The central component of the present compact stand-alone network data storage and viewing device 10 (FIG. 1) is the processor 11, on the basis of which the device's operating system operates. The operating system controls operation of all programs (including power supply control programs, device module activity monitoring programs, user authentication programs, data processing programs and others), modules and devices. To speed up the operation of the operating system and programs, the device includes the random access memory 12. The long-term memory 13 stores all user data and operating system and program files. Via the external storage media interaction module 14, the device can exchange data with external storage media 21 such as SD memory cards, MMC, Compact Flash, Memory Stick, USB Flash Drive, external hard drive and the like. To achieve this, when connecting the external physical data medium 21 to the device 10 via the external physical data media interaction module 14, the device's module activity monitoring program detects a new connection and activates the user authentication program that activates the device authentication module 15.

Users enter their credentials, for example, a fingerprint to the fingerprint scanner, and the authentication program compares the received credentials with the user credentials stored in the long-term memory 13. In case of successful authentication, the data processing program is activated, which allows the user to select the necessary actions through the user interface on the internal data display 16, such as data copying, data transfer, data creation time synchronization, browsing, and the like. When a user has selected necessary actions, the data processing program starts the data exchange process between the external physical data media 21 and the device 10.

Due to the different speeds of operation of various storage devices, the operating system can pre-copy data to RAM 12 to speed up the data exchange process. The data to be stored in the device 10 is recorded in the long-term memory 13. Through the wireless communication module 17, the device 10 exchanges data with network services 25, between other external devices 23 and 24 with and without the wireless communication module, but connected to the network infrastructure. The device module activity monitoring program continually checks the activity of the wireless communication module 17 and, in case activity is detected, attempts to contact the paired device 23, 24 (i.e. the device with which the communication was pre-reconciled) via near field wireless communication (Bluetooth, NFC and the like) and/or through the local network and/or the Internet 27 (via WiFi, 4G, 5G (data transfer via mobile communication) and the like). When access to the Internet 27 is detected, the device 10 exchanges data with the peer-to-peer network coordination server 26 to update information on paired devices 23, 24 and data for exchange, as well as other network services 25 such as Yandex.Disk, Twitter, Facebook, etc.

The multimedia module 18 may include interfaces such as HDMI, and/or DVI, and/or MHL, or the like. When the external display device 22, such as a monitor and/or television and/or projector or the like, is connected via the multimedia module 18, the device module activity monitoring program activates the user authentication program, which activates the device authentication module 15. Users enter their credentials, for example, their fingerprint into the fingerprint scanner, and the authentication program compares the received credentials with the user credentials stored in the device 10. In case of successful authentication, the user selected data starts to be displayed to the external display device 22, thus allowing the data stored in the device 10 to be viewed with high quality and convenience for group viewing. The independent power supply source 20, for example a battery, allows the device 10 to operate in field conditions. The power supply control program of the device 10 controls the power supply of the device built-in modules 11-20, and also monitors the charge of the battery 20.

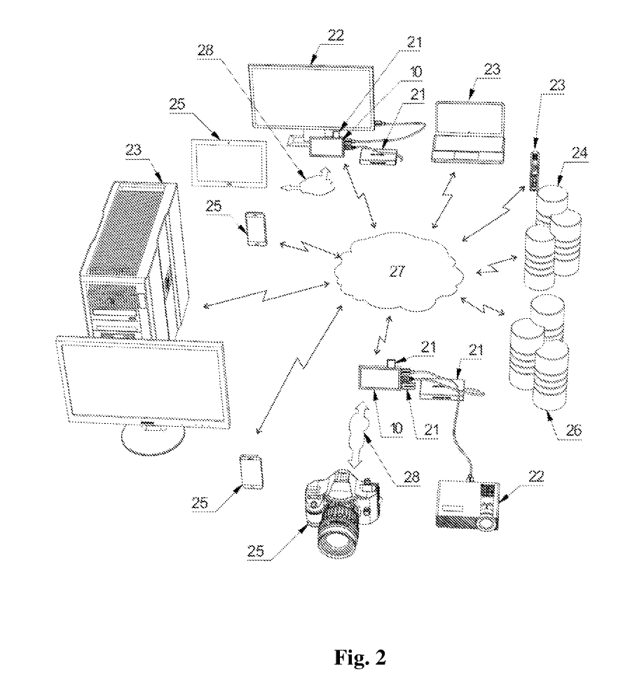

FIG. 2 shows the device 10 in interaction with other external devices 21-26. The interaction can be performed both via a physical connection and via the wireless infrastructure 27-28. At least one external storage device 21, at least one information external display device 22 (monitor, projector, etc.), and at least one computer system configuration 23 can be connected to the device, data exchange with which is performed via the local network or the Internet 27. At least one network service 25 (Facebook, Instagram, Dropbox, Netflix, Twitter, VKontakte and the like) can be connected to the device 10, data exchange with which is performed via the local network or the Internet 27. At least one peer-to-peer network coordination server 26 and at least one mobile device 24 (for example, a tablet, mobile phone, camera, etc.) can be connected to the device, data exchange with which is performed via either the local network or the Internet 27, or via near field wireless communication 28 (Bluetooth, NFC and the like).

For data exchange between the device 10 and physical media 21, such as a USB Flash Drive (data storage device with universal serial bus), external hard drive, SD Card (Secure Digital Card), MMC (MultiMedia Card), Memory Stick, Compact Flash and the like, the physical medium 21 is connected via the external data media interaction module 14. The module activity monitoring program of the device 10 detects a new connection and activates the user authentication program that activates the device authentication module 15. The user enters their credentials, and the authentication program compares the received credentials with the user credentials stored in the device 10. Upon a successful authentication the data processing program is activated, which allows performing various operations with data, such as copying, transfer, modification date synchronization, viewing, and others. Besides, using the data processing program, the data pairing between devices or services can be set up.

For data exchange between the device 10 and external devices 23, 24 or network services 25, the data pairing for exchange is configured. To do this, after the successful authentication, using the authentication program, the data processing program is activated on the device 10 and data and parameters for the exchange (copying, moving, modification date synchronization, etc.) are determined. After that, the data processing program generates a secret access key for data exchange, which is transmitted to the peer-to-peer network coordination server 26 via the wireless communication module 17 and the local network or the Internet 27. At the same time, this access key is transmitted to the user of the target external device via third-party information exchange means, such as voice communication, short message service, e-mail, etc. Having received the private access key, the user of the paired device 23, 24 starts a copy of their data processing program and enters the secret access key. The data processing program of the paired device 23, 24 transmits this secret key via the local network or the Internet 27 to the peer-to-peer network coordination server 26, and in response, it receives information on the exchange parameters and the data location. After that, the pairing of devices is considered complete and the subsequent data exchange can be performed automatically. In the same way, the user of the external device 23, 24 can initiate the process of pairing their data, by using their copy of the data processing program, with other devices, for example, with the device 10.

Data exchange via the wireless communication module 17 by near field wireless communication lines (Bluetooth, NFC and the like) is performed after the module activity monitoring program of the device 10 has detected the activity of the wireless communication module 17, which activates the user authentication program. After successful authentication, the data processing program is activated, which exchanges paired data or allows setting new data to be paired. The data pairing information will be transferred to the peer-to-peer network coordination server 26 upon the first connection to the Internet 27. The data can be later exchanged between the devices via the local network or the Internet 27 with the help of the wireless communication module 17.

By changing the attributes of files and folders, such as file creation date, file name, geo-tags, service or folder membership attributes and other attributes in the data processing program, the user affects the sorting results of the data displayed for viewing, and also on the parameters of data exchange between various paired data, such as a list of paired data, restrictions on exchanging data with other devices, etc.

The independent power supply source 20 allows use of the device 10 in any convenient place. In stationary conditions, the device 10 can be operated from the mains.

It is assumed that most of time under stationary conditions, the device 10 is connected to the high-resolution information external display device 22, such as a television, monitor or projector via the multimedia module 18, allowing a large number of high-quality media files to be viewed from the long-term memory 13 without delays caused by the data transfer via the wireless communication lines 27, 28 between the devices. Provided that the data is paired between the devices, new data stored in the memory of one of the paired devices and subject to the pairing conditions (location, list of paired devices, modification time synchronization, etc.) can be transferred to other paired devices and displayed for viewing.

What is claimed is:

1. A compact stand-alone network data storage and viewing device comprising:
a central processing unit with a random access memory;
a long-term memory;
a module for interacting with external physical data media;
a wireless communication module;
an independent power supply source;
an built-in display; and
an audio module,
wherein the device further comprises:
an authentication module configured to input user data into the long-term memory, the central processing unit is configured to request authentication data from the long-term memory, compare the requested authentication data with the user input data, and, in case of successful authentication, transfer control to the data processing program;
a high-resolution multimedia data transmission module; and the wireless communication module comprises:
near field communication media configured to collect multimedia data from external devices to the long-term memory and to exchange multimedia data stored in the long-term memory with external devices for group use of multimedia data and to maintain their actuality; and
communication media in the Internet configured to collect multimedia data from remote devices and record the multimedia data into the long-term memory and to exchange multimedia data stored in the long-term memory with other remote devices for group use of multimedia data and support their actuality, the built-in display being a high-resolution touch screen, and the central processing unit is configured to monitor and control the activity and operation of the specified modules, and interface with external devices.

2. The device of claim 1, wherein the long-term memory is a hard drive and/or a solid-state disk.

3. The device of claim 1, wherein the module for interaction with external physical media is configured to provide data exchange with SD memory cards and/or MMC and/or Compact Flash, Memory Stick and/or USB Flash Drive and/or an external hard drive.

4. The device of claim 1, wherein the near field communication media include built-in Bluetooth devices and/or NFC and/or wireless personal network devices.

5. The device of claim 1, wherein the external devices comprise mobile phones and/or tablets and/or cameras and/or devices supporting near field communication.

6. The device of claim 1, wherein the communication media in the Internet include built-in WiFi devices.

7. The device of claim 1, wherein the communication media in the Internet include built-in LiFi devices.

8. The device of claim 6, wherein the communication media in the Internet are configured to allow exchanging data with devices in a peer-to-peer network using network services.

9. The device of claim 6, wherein communication media in the Internet communication media in the Internet are configured to allow exchanging data with devices in a peer-to-peer network using cloud storage.

10. The device of claim 6, wherein the communication media in the Internet communication media in the Internet are configured to allow exchanging data with devices in a peer-to-peer network using the Internet network services.

11. The device of claim 6, wherein the communication media in the Internet are configured to allow exchanging data with devices in a peer-to-peer network using the Internet social networks.

12. The device of claim 6, wherein the communication media in the Internet are configured to allow exchanging data with devices in a hybrid network using network services.

13. The device of claim 6, wherein the communication media in the Internet are configured to allow exchanging data with devices in a hybrid network using cloud storage.

14. The device of claim 6, wherein the communication media in the Internet are configured to allow exchanging data with devices in a hybrid network using the Internet network services.

15. The device of claim 6, wherein the communication media in the Internet are configured to allow exchanging data with devices in a hybrid network using the Internet social networks.

16. The device of claim 1, wherein the authentication module are configured built-in to authenticate with the digital image of the user's fingerprint and/or retina.

17. The device of claim 1, wherein the high-resolution multimedia data transmission module comprises high-resolution digital video data and multi-channel digital audio signals transmission devices.

18. The device of claim 17, wherein as high-resolution digital video data and multi-channel digital audio signals transmission devices the HDMI and/or DVI and/or MHL interfaces are used.

19. The device of claim 1, further comprising an external display device for high-resolution multimedia data.

20. The device of claim 19, wherein the external high-resolution multimedia display device is configured to allow group viewing.
